(19) United States
(12) Patent Application Publication
(10) Pub. No.: US 2012/0120537 A1
(43) Pub. Date: May 17, 2012

(54) CURRENT FAULT LIMITER WITH LIVE TANK

(75) Inventor: Michael P. Ross, Madison, WI (US)

(73) Assignee: American Superconductor Corporation, Devens, MA (US)

(21) Appl. No.: 12/945,974

(22) Filed: Nov. 15, 2010

(51) Int. Cl. H02H 9/02

(52) U.S. Cl. 361/93.9

(57) ABSTRACT

An apparatus for limiting fault current in a power distribution system. Such an apparatus includes a tank for containing a cryogenic fluid; and a winding supported in the tank, the winding being electrically connected to the tank. The winding and the tank are at the same electrical potential.

### FIELD OF DISCLOSURE

This disclosure relates to power distribution systems, and in particular, to devices for addressing current faults in such systems.

### BACKGROUND

Power distribution systems occasionally experience sudden surges of current. These surges are often referred to as “current faults.” Because the current surge is often quite large, it is important that they be controlled or limited in some way.

It is known to provide current fault limiters. In some cases, current fault limiters take the form of windings suspended in tanks filled with cryogenic fluid. The cryogenic fluid serves to cool the windings, thus causing the windings to become superconducting.

A risk associated with the known current fault limiters arises from the possibility of arcing between the windings and the walls of the tank. This arcing tends to heat, and possibly boil, the cryogenic fluid. Rapid boiling of cryogenic fluid can suddenly increase gas pressure within the tank and cause a catastrophic rupture or explosion.

To some extent, the choice of a cryogenic liquid having suitable insulating properties can reduce this risk. In addition, one can reduce the risk of arcing by providing sufficient clearance between the walls of the tank and the winding.

### SUMMARY

In one aspect, the invention features an apparatus for limiting fault current in a power distribution system. Such an apparatus includes a tank for containing a cryogenic fluid; and a winding supported in the tank, the winding being electrically connected to the tank. The winding and the tank are at the same electrical potential.

In some embodiments, the tank includes walls forming an aperture in the tank through which a portion of the winding in the tank extends. Among these embodiments are those that include thermally insulating bushings configured to receive the portion of the winding.

Among the embodiments of the invention are those that also include an electrical insulator electrically insulating the tank from ground. In some of these embodiments, the insulator includes a support stand. In others of these embodiments, the insulator includes an exterior tank surrounding the tank and separated from the tank by an insulator.

Some embodiments also include a switch for selectively connecting the winding to a load. Among these are embodiments that also include a controller for controlling the switch, and those that further include a sensor for providing, to the controller, data for determining whether a current fault has occurred.

In some embodiments, the apparatus also includes an electrical connector for providing an electrical connection between the winding and the tank. Among these are those in which the connector is integrated into a bushing, and those in which the connector includes a conductor extending from the winding to the tank.

Other embodiments include those having means for thermally insulating the tank, means for electrically insulating the tank, means for electrically connecting the tank and the winding, means for selectively disconnecting the winding from a load, or any combination of the foregoing.

A variety of windings can be used in the apparatus. However, in some embodiments, the winding includes a winding that transitions between a superconducting state and a non-superconducting state.

In another aspect, the invention features an apparatus for use in a power distribution system. Such an apparatus includes a live tank; and a fault current limiter contained in the tank, the fault current limiter transforming from a superconducting state into a non-superconducting state in response to fault current.

In some embodiments, the live tank is configured to contain a cryogenic fluid.

In another aspect, the invention features an electric power plant for providing electric power to a power grid. Such a power plant includes a generator for generating electric power; a variable resistance path extending between the generator and the power grid; means for increasing resistance on the second path in response to a current fault; and a tank enclosing the means for increasing resistance, the tank being maintained at line potential.

These and other features of the invention will be apparent from the following detailed description and the accompanying figures, in which:

### DESCRIPTION OF THE FIGURES

FIG. 1 shows a power distribution system that includes a current fault limiter in a tank;

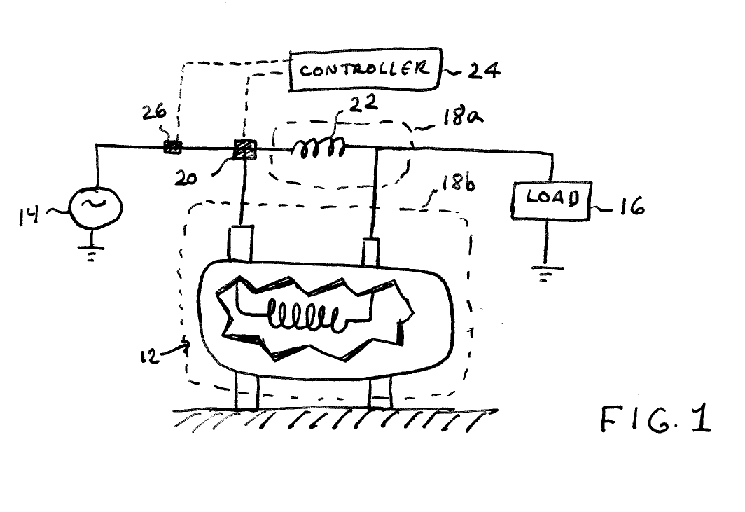

FIG. 2 shows a more detailed view of the current fault limiter and tank shown in FIG. 1; and

FIG. 3 shows an alternative embodiment of the tank in FIG. 2.

### DETAILED DESCRIPTION

A power distribution system 10 incorporating a fault current limiter 12 includes a power generator 14 connected to a load 16, such as an electric power utility, via one of two alternative paths 18a, 18b selected by a switch 20. The first path 18a passes through a reactor 22 and on to the load 16, whereas the second path 18b passes through the fault current limiter 12. A controller 24 opens or closes the switch 20, and hence selects the path 18a, 18b, on the basis of information provided to it by a current sensor 26.

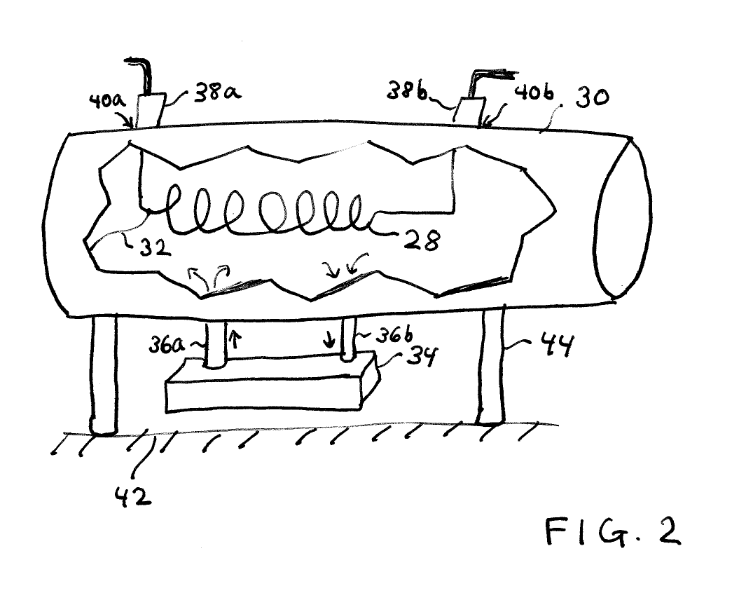

The fault current limiter 12, shown in more detail in FIG. 2, features a winding 28 suspended within a tank 30 The winding 28 is made of a material that, when sufficiently cooled, becomes a superconductor.

A tank connector 32 electrically connects the winding 28 and the tank 30. As a result, the tank 30 and the winding 28 are at the same potential. When the winding 28 is at line potential, the tank 30 is also at line potential. For this reason, the tank 30 is said to be a “live” tank, as distinguished from a “dead” tank in which the tank is maintained at ground potential.

A refrigeration system 34 circulates cryogenic fluid into and out of the tank 30 via first and second conduits 36a, 36b. A pair of bushings 38a, 38b located at apertures 40a, 40b through which electric current flows into and out of the tank 30 provides thermal insulation to suppress entry of heat into the tank 30. However, because the tank 30 is electrically connected to, and hence at the same potential as, the superconducting winding 28, there is no need for the bushings 38a, 38b to also provide electrical insulation between the tank 30 and the winding 28. This greatly reduces the size and cost of the bushings 38a, 38b.

In the particular embodiment shown in FIG. 2, the tank connector 32 is at one end of the winding 28. However, the tank connector 32 can also extend from the middle of the winding 28 to the tank 30. In addition, the tank connector 32 can be integrated into one or both bushings 38a, 38b.

Since the tank 30 is at the same potential as the winding 28, it is preferable that the tank itself be electrically insulated from ground 42. This is achieved by providing an insulating stand 44 between the tank 30 and ground 42. Such stands 44 are commercially available for a variety of voltage levels.

In operation, the winding 28 is normally superconducting, and hence presents virtually no resistance to current flowing toward the load 16. Upon occurrence of a current fault, current in the winding 28 exceeds the critical current. As a result, the winding 28 loses its superconducting properties and begins to present considerable resistance to current flow along the second path 18b. This, in turn, tends to quench the excess current. Meanwhile, shortly after detecting the occurrence of a current fault, the controller 24 sets the switch 20. This diverts the current from the second path 18b to the first path 18a, where it encounters the reactor 22. This reactor 22 then develops a voltage tending to resist the current.

The use of a live tank 30, instead of a dead tank essentially eliminates the risk of arcing between the winding 28 and the tank 30. This essentially eliminates the risk of boiling the cryogenic fluid, and thus eliminates the pressure spikes that may result in rupture or catastrophic failure of the tank 30. The reduced likelihood of arcing also reduces the requirement for mechanical strength sufficient to accommodate pressure spikes, and thus reduces the cost of the tank 30.

In addition, because of the significant reduction in the risk of arcing between the winding 28 and tank 30, clearance between the tank 30 and the winding 28 can be reduced. This means that the tank 30 can be made significantly smaller. In addition, the insulating properties of the cryogenic fluid filling the tank 30 become less important. For example, instead of liquid nitrogen, liquid helium, liquid neon, or liquid air can be used.

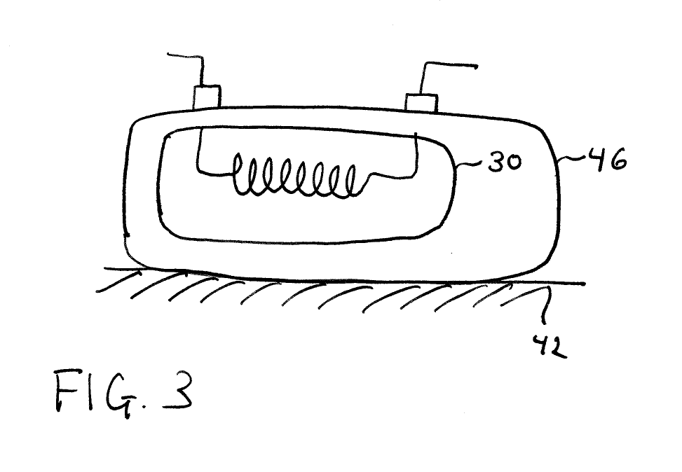

In an alternative embodiment, the tank 30 can be located within an outer tank 46, as shown in FIG. 3, which is filled with an insulating liquid. In such a case, the outer tank 46 serves as an insulator and thus eliminates the need for a stand 44. In addition, because the outer tank 46 is not at line potential, there is no longer a need to provide a safety barrier to prevent for plant workers from inadvertently being electrocuted by inadvertently touching the live tank 30.

Having described the invention, and a preferred embodiment thereof, what we claim as new, and secured by Letters Patent is:

1. An apparatus for limiting fault current in a power distribution system, said apparatus comprising:
a tank for containing a cryogenic fluid; and
a winding supported in said tank, said winding being electrically connected to said tank,
whereby said winding and said tank are at the same electrical potential.

2. The apparatus of claim 1, wherein said tank comprises walls forming an aperture in said tank through which a portion of said winding in said tank extends.

3. The apparatus of claim 2, further comprising thermally insulating bushings configured to receive said portion of said winding.

4. The apparatus of claim 1, further comprising an electrical insulator electrically insulating said tank from ground.

5. The apparatus of claim 4, wherein said insulator comprises a support stand.

6. The apparatus of claim 4, wherein said insulator comprises an exterior tank surrounding said tank and separated from said tank by an insulator.

7. The apparatus of claim 1, further comprising a switch for selectively connecting said winding to a load.

8. The apparatus of claim 7, further comprising a controller for controlling said switch.

9. The apparatus of claim 8, further comprising a sensor for providing data to the controller, said data being data for determining whether a current fault has occurred.

10. The apparatus of claim 1, further comprising an electrical connector for providing an electrical connection between said winding and said tank.

11. The apparatus of claim 10, wherein the connector is integrated into a bushing.

12. The apparatus of claim 10, wherein the connector comprises a conductor extending from the winding to the tank.

13. The apparatus of claim 1, further comprising means for thermally insulating said tank.

14. The apparatus of claim 1, further comprising means for electrically insulating said tank.

15. The apparatus of claim 1, further comprising means for electrically connecting said tank and said winding.

16. The apparatus of claim 1, wherein said winding comprises a winding that transitions between a superconducting state and a non-superconducting state.

17. The apparatus of claim 1, further comprising means for selectively disconnecting said winding from a load.

18. An apparatus for use in a power distribution system, said apparatus comprising:
a live tank; and
a fault current limiter contained in said tank, said fault current limiter transforming from a superconducting state into a non-superconducting state in response to fault current.

19. The apparatus of claim 18, wherein the live tank is configured to contain a cryogenic fluid.

20. An electric power plant for providing electric power to a power grid, said power plant comprising:
a generator for generating electric power;
a variable resistance path extending between said generator and said power grid;
means for increasing resistance on said second path in response to a current fault; and
a tank enclosing said means for increasing resistance, said tank being maintained at line potential.
